(19) United States
(12) Patent Application Publication
(10) Pub. No.: US 2010/0076888 A1
(43) Pub. Date: Mar. 25, 2010

(54) SYSTEM AND METHOD FOR PROVISIONING A CONTROLLED SECONDARY MARKET FOR SMALL DOLLAR DEPOSITS AND LENDING

(76) Inventors: Mark A. Ernst, Mission Hills, KS (US); John W. Thompson, Overland Park, KS (US); Bernard M. Wilson, Leawood, KS (US)

Correspondence Address: HUSCH BLACKWELL SANDERS LLP, 4801 Main Street, Suite 1000, KANSAS CITY, MO, 64112, US

(21) Appl. No.: 12/358,699

(22) Filed: Jan. 23, 2009

Related U.S. Application Data
(60) Provisional application No. 61/100,071, filed on Sep. 25, 2008.

(51) Int. Cl. G06Q 40/00

(52) U.S. Cl. 705/38

(57) ABSTRACT

A system for aggregating retail financial services distribution partners and providing real time, automated matching of the tailored products being delivered to clients by distribution partners to available financing and deposit locations. Secondary market participants are also assembled to provide financing capacity and locations for deposits of the system's marketplace.

### CROSS-REFERENCE TO RELATED APPLICATIONS

This application claims priority to and the benefit of U.S. Provisional Application Ser. No. 61/100,071, filed Sep. 25, 2008, which document is hereby incorporated by reference to the extent permitted by law.

### BACKGROUND OF INVENTION

The present invention relates to systems and methods for providing a controlled secondary market for small dollar deposits and lending. More specifically, to the present invention relates to the aggregation of retail financial services.

Retail banks and other financial institutions (FI's) have a difficult time effectively participating in the delivery of consumer lending and other banking services to low- and moderate-income (LMI) families using small-dollar banking services (SDBS). The current distribution network that retail banks have developed is designed to support clients with characteristics that generate a much higher revenue profit per unit. Essentially, loaning a small amount of money to an LMI family takes approximately as much time and effort as making a single, larger loan to a higher income family, but nets a significantly smaller return than would the larger loan. In order to get the same return as the larger loan, multiple smaller loans would need to be made, taking substantially more time and effort than would be required for merely making the single, larger loan. Further, product features such as minimum required balances or standard underwriting procedures are used as proxies to attract profitable customers and dissuade unprofitable customers, which often include LMI families.

Money center banks, however, do participate in this market by funding loans for retail distribution for various alternative financial services (AFS) models that have developed in the absence of retail bank presences. This market is a huge growth market which includes consumer lending, transactions, savings, asset insurance, tax credits, government benefits, etc. However, it is characterized by highly fragmented, single-product AFS retail providers, such as Tax Refund Advance Loan Providers, Payday Lenders, Check Cashers, Pawn Shops, etc. There is also a lack of adequate risk management in this market, as AFS providers have not invested in underwriting innovation for non-traditional borrowers. AFS providers also suffer from inconsistent funding sources, especially during seasonal peaks such as tax refund time or during times of tight credit. As a result, AFS providers have inadequate scale and high unit costs, which has led to higher consumer prices, poor structures and reduced access to credit.

AFS providers have captured this market at the expense of traditional Banks—there are over 40 million unbanked or under-banked households, representing more than 106 million individuals that now use AFS services. Further, AFS providers generated approximately $18 billion in earnings in 2006, and a compound annual growth rate of 9-14% over the last five years. These highly fragmented and localized retail stores have experienced over 440% growth in the last eight years to almost 40,000 retail locations.

Current banking systems do not allow for retail banks to profitably serve this segment of the market, and thus they do not allow retail banks the ability to meet various stipulations of the Community Reinvestment Act requiring lending, investment and the provision of services to LMI segments in certain geographic areas. However, as discussed above, the cost of acquiring small dollar banking services clients is high and the current product solutions are not designed to attract, retain and provide “up sell” opportunities to SDBS clients.

### SUMMARY OF THE INVENTION

One or more embodiments of the present invention relate to a system for aggregating retail financial services distribution partners and providing real time, automated matching of the tailored products being delivered to clients by distribution partners to available financing and deposit locations. Secondary market participants are also assembled to provide financing capacity and locations for deposits of the system's marketplace.

In a preferred embodiment of the present invention, a system and method are provided for the automated matching of available financing and deposit locations to the market of financial products being delivered to clients through financial partners via a small dollar banking switch (“SDB switch” or “switch”). In a preferred embodiment, retail financial services distribution partners are aggregated in order to assemble scaled access to SDB services for traditional banking providers. These retail financial distribution partners distribute tailored products, such as transactions, savings, lending, insurance, etc., to clients via a SDB switch that uses various algorithms to provide real-time, automated matching of available financing and deposit locations to the market of the tailored financial products being delivered to clients by the distribution partners. Secondary market participants, such as Financing Providers and SDB Service Providers, also called “Participant Banks,” though they need not be banks, are assembled to provide financing capacity and locations for deposits for the created marketplace. It is noted that a single product could be split between multiple secondary market participants as needed for purposes such as distribution of risk.

In another embodiment of the present invention, an SDB switch allows third-party banks, FIs and other financing partners to specify parameters of market participation within the marketplace and fulfill against those participation parameters in real time by providing loan financing, deposit receipt, and other services to the switch, thereby permitting the presence of correspondent relationships as well as the automatic assembly of pools of such services in real time to create a marketplace for SDB services. In this embodiment, financial products are characterized against the market participation parameters, and a computer system including a SDB Switch matches available providers of financing and market services against requested financial products within participating distribution networks. The SDB switch may also bundle participants by contract, or participants may be automatically assembled by the switch. Geography may also be a component of the matching process. In this embodiment, the necessary reporting, metrics and documentation may be provided to permit the application of market-making activities for purposes of regulators evaluation against the requirements of the Community Reinvestment Act.

In another preferred embodiment, a dynamic SDB market-making and underwriting model is envisioned in which a computer system operates provide liquidity for SDB products and service delivery by incorporating multiple risk and underwriting parameters with available capacity for loan financing, deposit acceptance, etc., provided by the SDB switch. The matching of short-term refund anticipation loans (RAL) with short-term financing using deposits of those loan proceeds into a banking account within the same banking charter includes a method of subsequently selling or transferring at least a portion of available deposits from RAL and refund anticipation checks (RAC) products to another bank in exchange for loan financing and participation. This includes a method of subsequently selling or transferring the loans (following origination) to another bank, regardless of whether that selling or transferring includes deposits as a component.

In a preferred embodiment, a method of providing small dollar services to low-middle income clients includes: a) receiving parameters from a Participant Bank, said parameters providing parameters, also called acceptance criteria, utilized to determine the acceptability of a client by said Participant Bank; b) accepting a product request from a said client; c) automatically matching said client with said Participant Bank where said client meets the acceptance criteria provided by said Participant Bank, and where said Participant Bank previously agreed to accept products having the terms associated with said product requested by said client; d) underwriting a transaction with said client where said client meets underwriting criteria; e) executing said transaction with said client; f) repeating steps a through e a plurality of times for a plurality of products and a plurality of clients; g) aggregating said plurality of products for said plurality of clients; and h) presenting said aggregated products to said Participant Bank for acceptance.

In another preferred embodiment, a method of providing small dollar services to low-middle income clients including: a) executing a Participation Agreement with a Participant Bank for participation in a created small dollar marketplace, where said Participant Bank agrees in said Participation Agreement to accept a financial product with specified terms in connection with a client who meets specified acceptance criteria, the home geography of a client being specified as a said criterion; b) matching a said client with said Participant Bank, where said client meets underwriting criteria and said acceptance criteria specified by said Participant Bank; c) offering said financial product to said client where said specified terms being substantially similar to terms of a product requested by said client, and where said financial product is available; d) executing a transaction with said client for said available financial product where said client meets underwriting criteria; and e) repeating steps (a) through (e) a plurality of times for a plurality of products and a plurality of clients.

### BRIEF DESCRIPTION OF THE SEVERAL VIEWS OF THE DRAWING

For a better understanding of the present invention, reference may be made to the accompanying drawings in which:

FIG. 1 is a simplified block diagram of an SDB Market Platform.

FIG. 2 is a block diagram of an SDB Market Platform in which the Retail Services and Financial Services Platform are expanded for a more detailed examination.

FIG. 3 is a block diagram an SDB Market Platform in which the Financial Services Platform is further highlighted.

FIG. 4. is a flow chart of an exemplary method for providing a controlled secondary market for small dollar deposits and lending.

FIG. 5 is a block diagram of a system for implementing the method shown in the flow chart in FIG. 4.

### DETAILED DESCRIPTION OF THE INVENTION

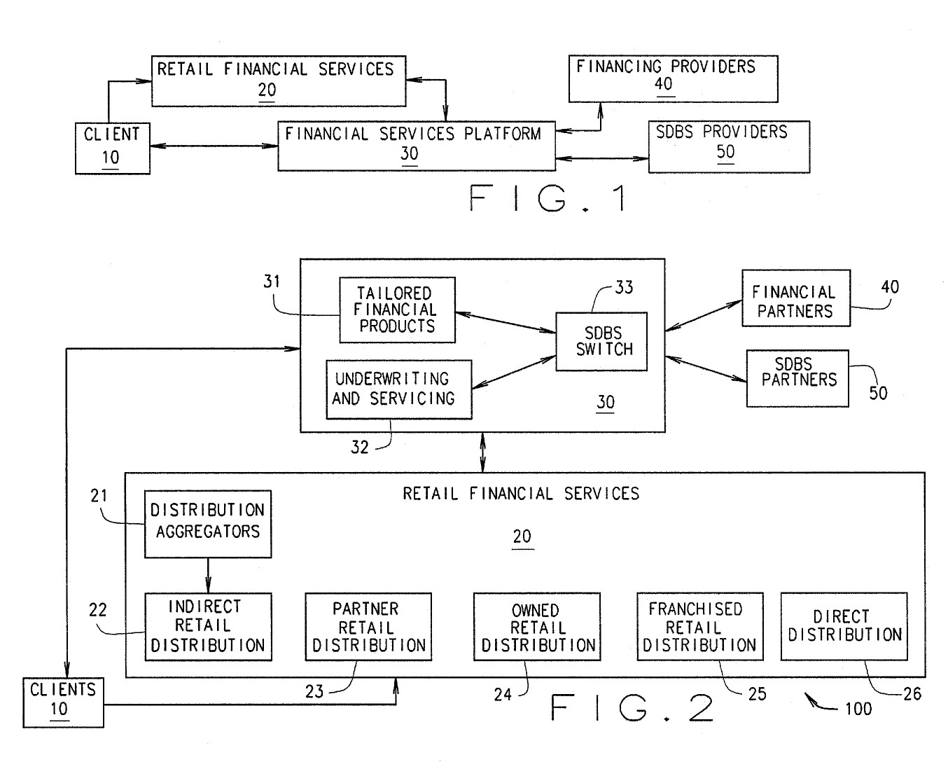

FIGS. 1 and 2 illustrate a simplified and an expanded block diagram, respectively, of an SDB Market Platform 100 according to an embodiment of the present invention. The SDB Market Platform 100 shown in FIG. 1 includes Clients 10, Retail Network 20, Financial Services Platform 30, Financing Providers 40 and SDB Services Providers 50. Financing Providers 40 and SDB Services Providers 50 may be the same entity, and may be referred to collectively or individually as “Participant Bank 40, 50”. Clients 10 may be individuals that have a need for banking services, and preferably for SDB services including deposit and lending products and various derivatives. Such Clients 10 may originate from various channels, including through direct contact (e.g., client phone call of website visit), via a financial services institution, or via retailers as discussed below.

Retail Network 20 is preferably a collection of entities that supply services to and/or act as end service providers to LMI clients or LMI client advisors. For example, Retail Network 20 may include: Direct Service Providers, such as companies that have relationships with LMI clients, such as cell phone providers, employers and payroll processors, or electronic infrastructure providers (pre-paid public transportation access); Manufacturers, such as baby formula manufacturers, regional and national associations such as the National Dairy Association or the Beef Council and other consortiums such as Farmer's Markets, which manufacturers are organized to better access LMI clients through, for example, incentives, discounts or extra features; Retailers, such as Walmart, Publix, Safeway, Dollar General and various online retailers such as Amazon and Ebay, which are a variety of large national and regional companies that have extended reach into LMI communities; Financial Services Providers including banks and other financial services organizations, card associations (e.g., Mastercard or Visa), Tax Preparers, Payday Lenders, and processing agents such as Metavanta, ATM owners and service operators, pre-paid card affinity providers, and financial networks such as GreenDot; and/or Government Agencies that provide transfer payments or services to LMI individuals, such as the Food and Nutrition Services, Social Security Administration, and Immigration and Naturalization Services.

As shown in FIG. 2, within Retail Network 20 there may be several different types of retail distribution. Indirect Retail Distribution 22 is retail storefront distribution acquired by indirect agreement between the Financial Services Platform 30 and Distribution Aggregators 21 (organizations that assemble retail distribution, e.g., Non-Governmental Organizations, Franchisers, etc.). Partner Retail Distribution 23 is retail storefront distribution acquired by direct agreement between the Financial Services Platform 30 and the retail owner. Owned Retail Distribution 24 are retail storefronts owned and operated by the Financial Services Platform 30. Franchised Retail Distribution 25 are retail storefronts owned and operated by franchisees, through franchise agreements managed by the Financial Services Platform 30. Direct Distribution 26 is direct to Client 10 acquisition, through the internet or similar technologies.

The Financial Services Platform 30 shown in FIG. 1 is a system which preferably includes an electronic SDB switch 33, as illustrated in FIG. 2, associated client/financing provider interface(s), and at least one database for storing the below discussed financial information. Preferably, the Financial Services Platform 30 also includes on-demand underwriting capabilities as well as product and client management business processing including but not limited to: features and pricing, disclosures, underwriting criteria and branding, and may include membership requirements such as parameters related to bank capitalization, FDIC or other regulator performance rating, current mix of business, etc. Such membership requirements would preferably require a Bank Participant 40, 50 to certify its willingness and ability to provide capacity, via accepting deposits and providing financing capacity for lending and other services, to the Platform 30. As illustrated in FIG. 2, Financial Services Platform 30 also includes Tailored Financial Products 31 and Underwiting and Services 32, as will be discussed in detail below.

The interface between the Platform's 30 SDB switch 33 (and associated database(s)) and a Bank Participant 40, 50, either via a web interface or a Bank Participant's 40, 50 legacy computer system, allows for the exchange of information relating to various aspects of data and parameters regarding Clients 10, such as the amount of the deposit, loan or other services needed. A Bank Participant 40, 50 would access the platform preferably via a secure web interface with various levels of access commensurate with a Participant Bank's 40, 50 level of participation for further security and relationship management. A Bank Participant's 40, 50 level of participation may involve on-demand, automated daily or other period limits on certain types of loans or deposits. In addition, a variety of information is exchanged between the Financial Services Platform 30 and the Participant Bank regarding the performance of the platform 30, such as various targeted and aggregated reports regarding subjects such operating capacity, financial analyses, tracking of payments/earnings, etc. Preferably, the data regarding the performance and actions of the Platform 30 is tracked and analyzed within the Platform 30 system. The Platform 30 interface is designed with broad functionality to offer various products and services and information gathering and analysis tools that can be customized based on level of participation. Preferably, the interface is a Distribution Management Interface (39), as discussed below.

Financing Providers 40 shown in FIGS. 1 and 2 preferably consist of various banks, bank holding companies, credit unions, Industrial Loan Chartered Banks of all charter types, Office of the Comptroller of the Currency (OCC), and Office of Thrift Supervision (OTS). Financing Providers 40 interact with the Financial Services Platform 30 through an interface, and preferably a web interface, to participate in daily, weekly, monthly or other customized durations of Small Dollar Loan (SDL) portfolios at a predetermined level or on demand based on market need or overall capital position. This allows Financing Providers 40 to hold short-term deposits that highly correlate to the duration of outstanding SDLs, which can dramatically improve financing capacity and lower costs, as will be discussed below. The Financial Services Platform 30 allows for the real-time ability to match lending and deposit taking with targeted communities in which a Financing Provider 40 operates, which further allows for significant efficiencies, including the development and dissemination of customized reporting and data analysis tools, with regard to Community Reinvestment Act responsibilities.

SDB Services Providers 50, shown in FIGS. 1 and 2, may include some of the same entities as the Financing Providers 40, namely banks, credit unions and other financial institutions, but also may comprise life or auto insurance companies, or other similar companies who wish to provide services to LMI Clients 10. An SDB Service Provider 50 may provide products, support and services for any or all of the following (non-inclusive) list: transaction services; savings and related products; lending products; investment products; currency exchange; and money transfers. The SDB switch 33 allows for the automation of the purchase, maintenance and sale of such products and services at an omnibus, individual or consortium account level. As above in connection with the Financing Providers 40, the Financial Services Platform 30 allows for customized reporting and data analysis tools.

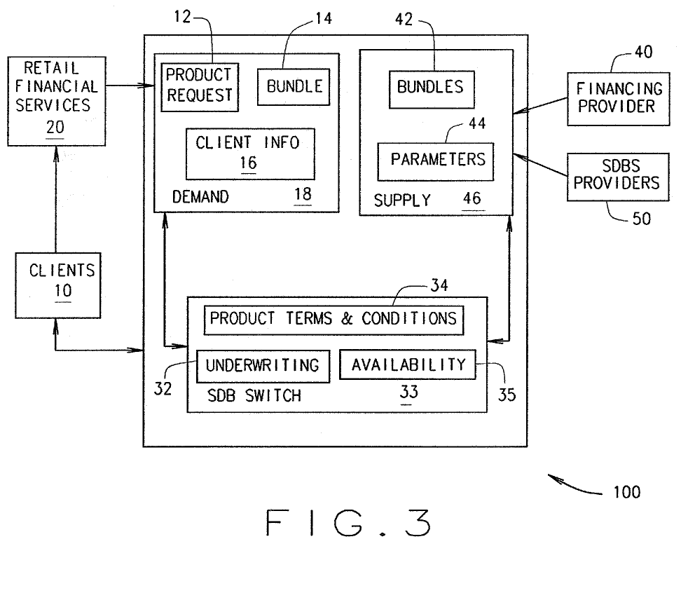

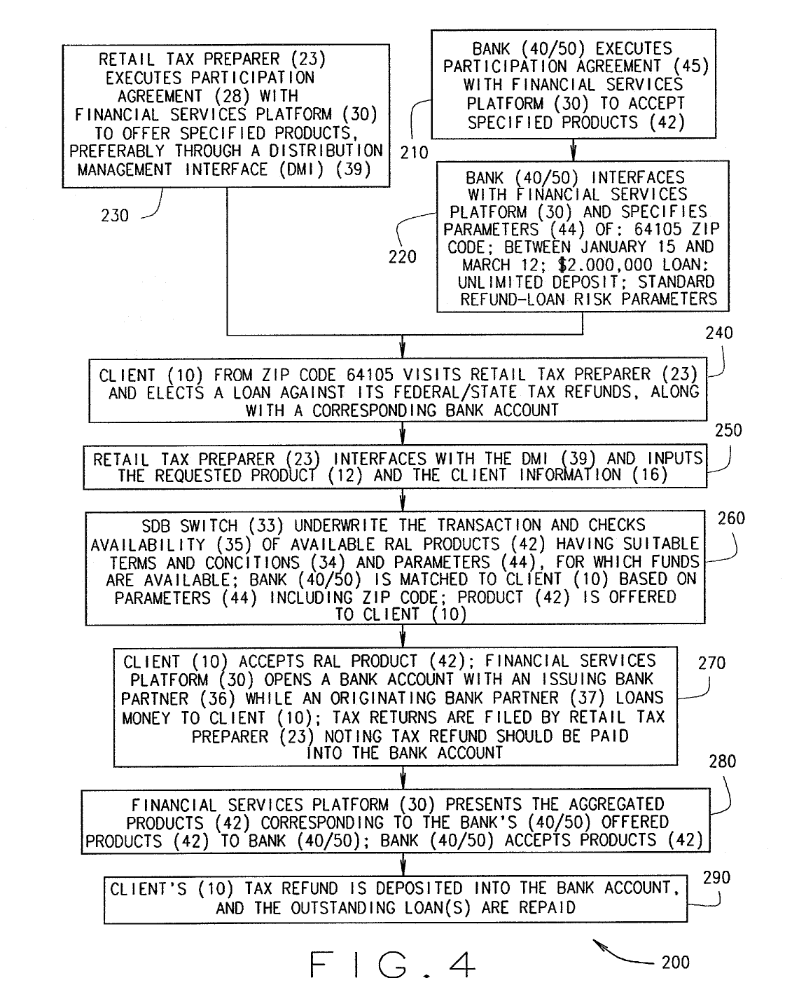

In operation, and as shown in FIG. 3, the Financial Services Platform 30 provides a common set of principles, rules and processes by which the participants in the SDB Market Platform 100 offer services to Clients 10. The Financial Services Platform 30 contracts with the Financing Providers 40 and SDB Service Providers 50 regarding Product Terms and Conditions 34 for a product or a more efficient bundle of products 42 (hereinafter referred to as Products 42 for simplicity) which the Financing Providers 40 and SDB Service Providers 50 will be willing to accept. Preferably, the Financial Services Platform 30 creates a substantially uniform Product 42 which various Financing Providers 40 and SDB Service Providers 50 accept for the purposes of conformity and uniformity, though Financing Providers 40 and SDB Service Providers 50 may propose their own such Products 42. The Financing Providers 40 and/or SDB Providers 50 then specify the Parameters 44, such as geography (postal code, country, state, etc.), risk profile (standard risk modeling, alternative risk measures, proprietary risk measures, customized risk measures, etc.), loan or deposit caps, time limits, product category, Originating Partner, etc., under which they are willing to accept a Product 42 request from a Client 10 at that time. Preferably, the parameters are input through a web interface or a program integrated into the systems of Financing Providers 40 or SDB Service Providers 50. Pre-agreed to Products 42 combined with the Parameters 44 under which the Products 42 will be accepted by Participant Banks 40, 50, form the Supply 46 offered to the Financial Services Platform 30 by Financing Providers 40 and SDB Service Providers 50. It is noted that a correspondent relationship may exist within the SDB switch 33 in which a Financing Provider 40 or SDB Service Provider 50 is aggregating other Financing Providers' 40 and SDB Service Providers' 50 interests.

The Financial Services Platform 30 then provides information regarding these Products 42 to members of the Retail Network 20 who have agreed to offer such Products 42 to Clients 10. When a Client 10 requests a Product 42 from a Retail Network member 20, the Retail Network member 20 informs the Financial Services Platform 30 of the Requested Product 12, preferably through a web interface or a program integrated into the systems of Retail Network members 20. The Retail Network member 20 also inputs standard Client Information 16, including zip code of residence and other information needed for underwriting. The Requested Products 12 or Requested Product Bundles 14 and Client Information 16 form the Demand 18 requested by the Client 10. It is noted that Clients 10 may alternatively access the SDB switch 33 directly.

Once both the Supply 46 and Demand 18 are known by the Financial Services Platform 30, the SDB switch 33 performs an Underwriting Function 32 relating to the Client 10 and Requested Product 12. When it is determined that the Client 10 is suitable for a Product 42 that has Product Terms and Conditions 34 acceptable to the Client, the SDB switch 33 performs a function checking the Availability 35 of Products 42 offered for Supply 46 by Financing Providers 40 or SDB Service Providers 50. When it is determined that a Product 42 is available, the SDB switch 33 then further matches the Client Information 16 to Parameters 44, such as comparing the home zip code of the Client 10 to the geographical area requested by a Financing Provider 40 or SDB Service Provider 50. Once a Client 10 has been successfully matched to a Product 42 offered by at least one Participant Bank 40, 50, and the parameters set by the Participant Bank 40, 50 are fulfilled, the transaction is executed between the Financial Services Platform 30 and the Client 10, and performance begins. The Client 10 then receives the Product 42.

After some period of time (daily, weekly, etc.) the Financial Services Platform 30 aggregates all of the individual transactions which were executed in connection with Products 42 offered by each Financing Provider 40 or SDB Service Provider 50 into single combined transactions, preferably one for each institution. A combined transaction is then presented to its respective Financing Provider 40 or SDB Service Provider 50. Whereas, for example, a bank would be unlikely to complete fifty $10,000 transactions with LMI clients in a single day, an aggregation of those transactions would result in a single $500,000 transaction which fulfills the bank's required terms and conditions and parameters is a far easier transaction to take on. The Financial Services Platform 30 would then preferably provide the Financing Provider 40 or SDB Service Provider 50 with a report and analysis of the Clients 10 sufficient to allow the Financing Provider 40 or SDB Service Provider 50 to certify its Community Reinvestment Act compliance.

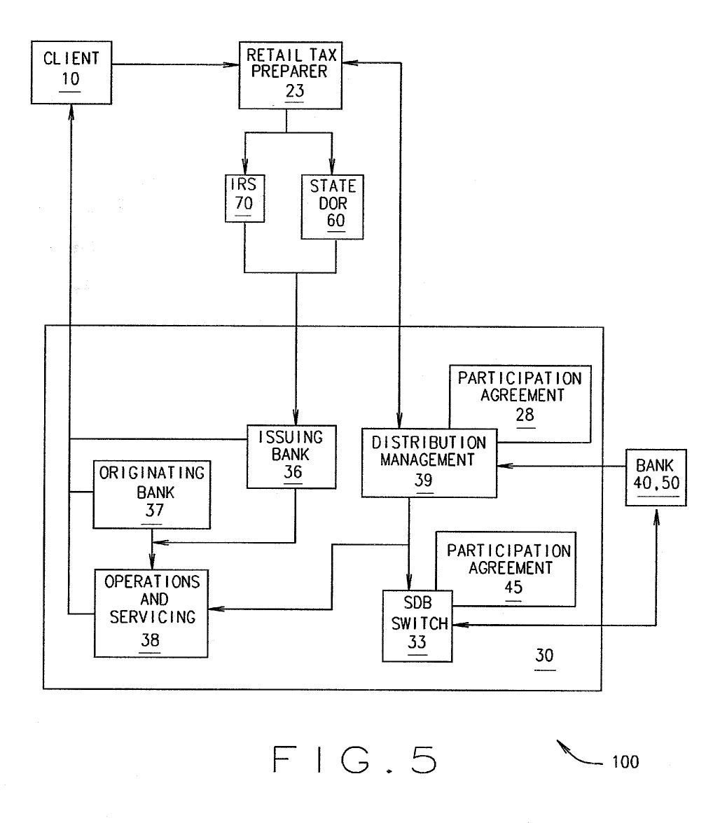

FIG. 4 illustrates a flow chart walking through the above described process of an exemplary interaction 200 between a Client 10 seeking a RAL, a Participant Bank 40, 50, and the Financial Services Platform 30. It is noted that this example should not be considered limiting, as the product may be any suitable product as discussed above, and the provider need not be a bank. FIG. 5 shows a block diagram of the system discussed in FIG. 4.

Initially, a Bank, which may be either or both a Financing Provider 40 seeking to make loans and take deposits, or an SDB Service Provider 50 seeking to offer various services to a Client 20 (hereinafter “Participant Bank 40, 50”), performs step 210 by executing a Participation Agreement (42) with Financial Services Platform 30 to accept Products 42 having specified Terms and Conditions 34. At step 220, Participant Bank 40, 50 interfaces with Financial Services Platform 30, preferably via a web interface or a computer program integrated into the systems of Participant Bank 40, 50, and specifies Parameters 44 for which it is willing to accept Products 42. In this example, Participant Bank 40, 50 specifies Parameters 44 of: 64105 zip code; between January 15 and March 12; a $2,000,000 loan cap; unlimited deposits; and standard refund-loan risk parameters. It is noted that these Parameters should be considered non-limiting, as Participant Bank 40, 50 could vary its terms based on factors such as time of year, availability of funds, etc. At step 230, a Partner Retail Distributor 23 who, for the purposes of this example is a Retail Tax Preparer 23, executes a Participation Agreement 28 with Financial Services Platform 30 to offer specified Products (42). Preferably, Retail Tax Preparer 23 accesses the Financial Services Platform 30 via Distribution Management Interface (DMI) 39 which may be a web interface or a computer program integrated into the systems of Retail Tax Preparer 23. The DMI 39 may house or have access to a database housing parameters and capacity information of Participant Banks 40, 50, and parameters regarding the needs of the distribution system, such as the number Clients 10 who want loans and transaction accounts. The DMI 39 may project the needs of each individual participant and of the entire distribution system.

Client 10, from zip code 64105 visits Retail Tax Preparer 23 between January 15 and March 12, and requests a loan against its Federal/State Tax Refunds, along with a corresponding bank account at step 240. Next, at step 250, Retail Tax Preparer 23 interfaces with the Financial Services Platform 30 through DMI 39 and inputs the Requested Product 12 and the Client Information 16. SDB switch 33 then underwrites the transaction when Client 10 is a suitable candidate, and checks the Availability 35 of RAL Products 42 having suitable Terms and Conditions 34 and Parameters 44 matching the Client Information 16, including zip code. Where Participant Bank 40, 50 has agreed, in Participation Agreement 45, to accept a Product 42 which fits the needs of Client's 10 Requested Product 12, and where Participant Bank's 40, 50 Parameters 44 are fulfilled, SDB switch 33 then offers the suitable Product 42—in this case a RAL product—to the Client 10 at step 260. Next, at step 270, Client 10 accepts a RAL Product 42 where all Terms and Conditions 34 are acceptable, and Financial Services Platform 30 executes the transaction and opens a Client 10 bank account with an Issuing Bank Partner 36 while an Originating Bank Partner 37 loans money to Client 10. Additionally, Retail Tax Preparer 23 files Client's 10 tax returns with the IRS 70 and State Department of Revenue 60, noting that tax refund monies up to an agreed upon amount should be paid into the above bank account.

Some time later, preferably daily or weekly, Financial Services Platform 30 aggregates those transactions executed in connection with Participant Bank 40, 50, so that Participant Bank 40, 50 may accept the transactions according to the terms of Participation Agreement 45, at step 280. Indeed, as Participant Bank 40, 50 has already agreed to accept transactions according to certain Terms and Conditions 34 and Parameters 44 under Participation Agreement 45, and as the transactions presented to Participant Bank 40, 50 comply with the agreed upon Terms and Conditions 34 and the inputted Parameters 44, Bank 40, 50 is essentially receiving aggregated transactions which cost it little time and effort to procure, which provide acceptable rates or return when aggregated compared to individual SDB transactions, and which qualify individually as LMI products for the purposes of the Community Reinvestment Act. At step 290, Client's 10 tax return is deposited into the bank account, and the outstanding loan(s) is (are) repaid. Outstanding loans and deposits may be managed with Bank 40, 50 on a daily basis, according to the terms of Participation Agreement 45.

The above discussed approach provides several other distribution efficiencies. AFS firms are ensured to have access to capital in order to provide SDB services to LMI clients, as there are multiple banks from which to automatically access capital. Additionally, underwriting criteria is based on individual data as opposed to aggregated data, allowing more accurate matching of products to clients. Another efficiency arises due to a bank's selection of a capacity and it's knowledge of the capacity remaining, allowing the bank to provide awareness of a dollar value availability.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

We claim:

1. A method of providing small dollar services to low-middle income clients, the method including:
a) receiving parameters from a Participant Bank, said parameters providing an acceptance criteria utilized to determine acceptance of a client by said Participant Bank;
b) accepting a product request from a said client;
c) automatically matching said client with said Participant Bank where said client meets the acceptance criteria provided by said Participant Bank, and where said Participant Bank previously agreed to accept products having the terms associated with said product requested by said client;
d) underwriting a transaction with said client where said client meets underwriting criteria;
e) executing said transaction with said client;
f) repeating steps a through e a plurality of times for a plurality of products and a plurality of clients;
g) aggregating said plurality of products for said plurality of clients; and
h) presenting said aggregated products to said Participant Bank for acceptance.

2. The method of claim 1, where the home geography of a client being a parameter.

3. The method of claim 1, where at least one of a risk profile of a client, a loan cap, a deposit limit, and a product category being a parameter.

4. The method of claim 1, further including:
receiving information regarding said client for use in said underwriting step.

5. The method of claim 1, wherein:
said parameters from a said Participant Bank and a said product request being accepted via a distribution management interface;
a said parameter being stored in a database communicably linked to an electronic financial services platform system; and
said financial services platform system performing said underwriting, said matching of a said requested product to a said provider, said aggregating and said presenting of said aggregated products.

6. The method of claim 1, further including:
at least beginning performing on said transaction.

7. The method of claim 1, further including:
reporting information regarding said aggregated products to said provider.

8. The method of claim 7, wherein reported information includes information regarding compliance with the Community Reinvestment Act.

9. A method of providing small dollar services to low-middle income clients, the method including:
a) executing a Participation Agreement with a Participant Bank for participation in a created small dollar marketplace, where said Participant Bank agrees in said Participation Agreement to accept a financial product with specified terms in connection with a client who meets specified acceptance criteria, the home geography of a client being specified as a said criterion;
b) matching a said client with said Participant Bank, where said client meets underwriting criteria and said acceptance criteria specified by said Participant Bank;
c) offering said financial product to said client where said specified terms being substantially similar to terms of a product requested by said client, and where said financial product is available;
d) executing a transaction with said client for said available financial product where said client meets underwriting criteria; and
e) repeating steps (a) through (e) a plurality of times for a plurality of products and a plurality of clients.

10. The method of claim 9, further including:
aggregating said plurality of products for said plurality of clients; and
presenting said aggregated products to said Participant Bank for acceptance.

11. The method of claim 10, further including:
reporting information regarding said aggregated products to said provider.

12. The method of claim 11, wherein reported information includes information regarding compliance with the Community Reinvestment Act.

13. The method of claim 9, where at least one of a risk profile of a client, a loan cap, a deposit limit, and a product category being criteria.

14. The method of claim 9, further including:
beginning performance on said transaction.
